(19) United States
(12) Patent Application Publication
(10) Pub. No.: US 2021/0174366 A1
(43) Pub. Date: Jun. 10, 2021

(54) METHODS AND APPARATUS FOR ELECTRONIC DETECTION OF FRAUDULENT TRANSACTIONS

(71) Applicant: Walmart Apollo, LLC, Bentonville, AR (US)

(72) Inventors: Yiyi ZENG, San Jose, CA (US); Linhong KANG, Sunnyvale, CA (US); Xu Si, Sunnyvale, CA (US); Arthi VIJAYAKUMAR, San Jose, CA (US)

(21) Appl. No.: 16/704,188

(22) Filed: Dec. 5, 2019

(51) Int. Cl. G06Q 20/40; G06N 20/00

(52) U.S. Cl. CPC G06Q 20/4016; G06Q 20/407; G06N 20/00

(57) ABSTRACT

This application relates to apparatus and methods for identifying fraudulent transactions. In some examples, a computing device trains a machine learning process with labelled historical transactions. The computing device may then receive transaction data identifying a purchase transaction, such as at a store or on a website. The computing device may execute the trained machine learning process based on the transaction data to generate a trust score. The machine learning process may determine whether the transaction is being made with a trusted device and trusted payment form, for example, to generate the trust score. The trust score may be used to determine whether the purchase transaction is to be allowed. In some examples, the transaction is allowed if the generated trust score is beyond a threshold. In some examples, the computing device may distrust a trusted device or payment form based on one or more events.

### TECHNICAL FIELD

The disclosure relates generally to fraud detection and, more specifically, to electronically identifying fraudulent retail transactions.

### BACKGROUND

Some transactions, such as some in-store or online retail transactions, are fraudulent. For example, a fraudster may attempt to purchase an item using a payment form, such as a credit card, belonging to another person. The fraudster may have stolen or found the payment form, and is now attempting to use the payment form for the purchase without permission from the payment form's rightful owner. In some cases, such as with in-store purchases, a fraudster may present another's identification (ID) card (e.g., driver's license), in addition to the payment form, when attempting to purchase the item, thereby facilitating the in-store fraudulent purchase.

Conveniences associated with online retail purchases also may facilitate fraudulent online transactions. For example, at least some retail websites allow a customer to make purchases without “signing in.” Instead of logging into an account of the customer on the website, the customer may choose to proceed under a “guest” option that does not require the customer to sign in to a particular account. As a result, a fraudster may make a purchase using an unauthorized payment form using the “guest” option. In addition, at least some retail websites allow a customer to ship purchased products to any address, such as a store location (e.g., ship-to-store), or a home location (e.g., ship-to-home). Although some retailers may require the showing of an ID when a customer shows to pick up a purchased item at a store, as noted above a fraudster may have an ID card of a victimized person. Thus, these online purchase conveniences may facilitate fraudulent online retail transactions.

In each of these examples, the fraudster is involved in a fraudulent activity. Fraudulent activities may cause victimized persons time and, in some examples, financial losses. For example, a victimized person may need to contact a financial institution and/or retailer to be credited for a fraudulent activity. In some examples, the victimized person may not be able to recover the financial losses. Fraudulent activities may also cause financial harm to a company, such as a retailer. For example, the true owner of the payment form may identify the fraudulent transaction and have the transaction cancelled. As such, the retailer may not receive payment for the purchase items. Thus, customers and retailers may benefit from the identification of fraudulent transactions before those transactions are completed.

### SUMMARY

The embodiments described herein are directed to automatically identifying fraudulent transactions. The embodiments may identify a fraudulent activity as it is taking place, for example, allowing a retailer to stop or not allow the transaction. In some examples, the embodiments may allow a retailer to identify a suspected fraudulent in-store or online purchase. The transaction may be disallowed if fraud is identified. As a result, the embodiments may allow customers to avoided being defrauded. The embodiments may also allow a retailer to decrease expenses related to fraudulent transactions.

In accordance with various embodiments, exemplary systems may be implemented in any suitable hardware or hardware and software, such as in any suitable computing device. For example, in some embodiments, a computing device is configured to receive purchase data identifying a purchase attempt (e.g., a current purchase attempt, such as at a store or on a website) using a first device and a first payment form. The computing device may also be configured to determine whether the first device is trusted to the first payment form based on first trust data obtained, for example, from a database. If the first device is trusted to the first payment form, the computing device is configured to generate a first trust value. If, however, the first device is not trusted to the second payment form, the computing device executes a machine learning process based on the purchase data, and generates a second trust value based on execution of the machine learning process. The computing device may further be configured to generate trust score data based on at least one of the first trust value or the second trust value. The computing device may be configured to transmit the trust score data to another computing device.

In some embodiments, a method is provided that includes receiving purchase data identifying a purchase attempt using a first device and a first payment form. The method may also include determining whether the first device is trusted to the first payment form based on first trust data obtained from a database. If the first device is trusted to the first payment form, the method further includes generating a first trust value. If the first device is not trusted to the second payment form, the method further includes executing a machine learning process based on the purchase data, and generating a second trust value based on execution of the machine learning process. The method may also include generating trust score data based on at least one of the first trust value or the second trust value. The method may further include transmitting the trust score data to another computing device.

In yet other embodiments, a non-transitory computer readable medium has instructions stored thereon, where the instructions, when executed by at least one processor, cause a computing device to perform operations that include receiving purchase data identifying a purchase attempt using a first device and a first payment form. The operations may also include determining whether the first device is trusted to the first payment form based on first trust data obtained from a database. If the first device is trusted to the first payment form, the operations further include generating a first trust value. If the first device is not trusted to the second payment form, the operations further include executing a machine learning process based on the purchase data, and generating a second trust value based on execution of the machine learning process. The operations may also include generating trust score data based on at least one of the first trust value or the second trust value. The operations may further include transmitting the trust score data to another computing device.

### BRIEF DESCRIPTION OF THE DRAWINGS

The features and advantages of the present disclosures will be more fully disclosed in, or rendered obvious by the following detailed descriptions of example embodiments. The detailed descriptions of the example embodiments are to be considered together with the accompanying drawings wherein like numbers refer to like parts and further wherein:

FIG. 1 is a block diagram of a fraud detection system in accordance with some embodiments;

FIG. 2 is a block diagram of the fraud detection computing device of the fraud detection system of FIG. 1 in accordance with some embodiments;

FIG. 3 is a block diagram illustrating examples of various portions of the fraud detection system of FIG. 1 in accordance with some embodiments;

FIG. 4 is a block diagram illustrating examples of various portions of the fraud detection computing device of FIG. 1 in accordance with some embodiments;

FIGS. 5A and 5B illustrate trusted and untrusted associations that may be determined by the fraud detection computing device of FIG. 1 in accordance with some embodiments;

FIGS. 6A and 6B illustrate trusted and untrusted associations that may be determined by the fraud detection computing device of FIG. 1 in accordance with some embodiments;

FIGS. 7A and 7B illustrate trusted and untrusted associations that may be determined by the fraud detection computing device of FIG. 1 in accordance with some embodiments;

FIGS. 8A and 8B illustrate trusted and untrusted associations that may be determined by the fraud detection computing device of FIG. 1 in accordance with some embodiments;

FIG. 9 illustrates various levels of trusted associations that may be determined by the fraud detection computing device of FIG. 1 in accordance with some embodiments;

FIG. 10 is a flowchart of an example method that can be carried out by the fraud detection system 100 of FIG. 1 in accordance with some embodiments; and

FIG. 11 is a flowchart of another example method that can be carried out by the fraud detection system 100 of FIG. 1 in accordance with some embodiments.

### DETAILED DESCRIPTION

The description of the preferred embodiments is intended to be read in connection with the accompanying drawings, which are to be considered part of the entire written description of these disclosures. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

It should be understood, however, that the present disclosure is not intended to be limited to the particular forms disclosed. Rather, the present disclosure covers all modifications, equivalents, and alternatives that fall within the spirit and scope of these exemplary embodiments. The terms “couple,” “coupled,” “operatively coupled,” “operatively connected,” and the like should be broadly understood to refer to connecting devices or components together either mechanically, electrically, wired, wirelessly, or otherwise, such that the connection allows the pertinent devices or components to operate (e.g., communicate) with each other as intended by virtue of that relationship.

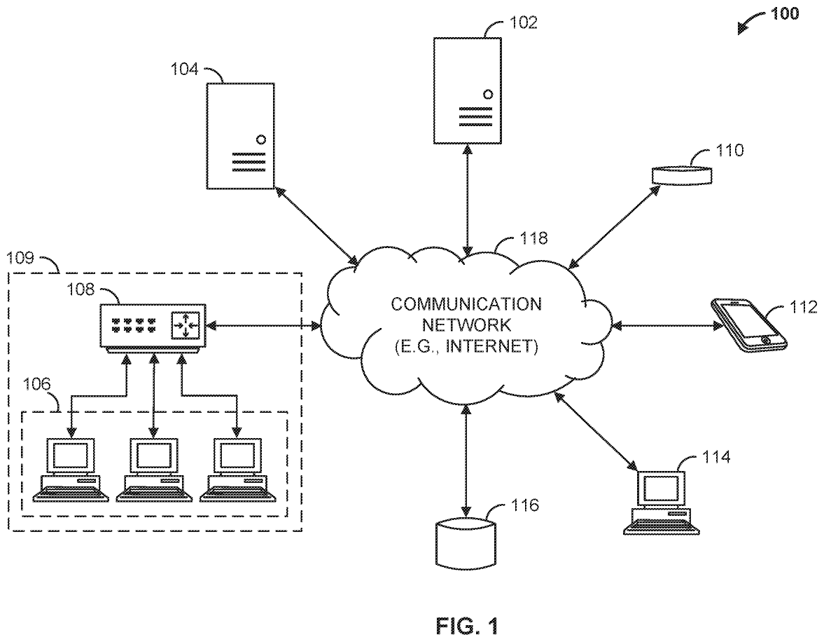

Turning to the drawings, FIG. 1 illustrates a block diagram of a fraud detection system 100 that includes a fraud detection computing device 102 (e.g., a server, such as an application server), a web server 104, workstation(s) 106, database 116, and multiple customer computing devices 110, 112, 114 operatively coupled over network 118. Fraud detection computing device 102, workstation(s) 106, web server 104, and multiple customer computing devices 110, 112, 114 can each be any suitable computing device that includes any hardware or hardware and software combination for processing and handling information. In addition, each can transmit data to, and receive data from, communication network 118.

For example, fraud detection computing device 102 can be a computer, a workstation, a laptop, a server such as a cloud-based server, or any other suitable device. Each of multiple customer computing devices 110, 112, 114 can be a mobile device such as a cellular phone, a laptop, a computer, a table, a personal assistant device, a voice assistant device, a digital assistant, or any other suitable device.

Additionally, each of fraud detection computing device 102, web server 104, workstations 106, and multiple customer computing devices 110, 112, 114 can include one or more processors, one or more field-programmable gate arrays (FPGAs), one or more application-specific integrated circuits (ASICs), one or more state machines, digital circuitry, or any other suitable circuitry.

Although FIG. 1 illustrates three customer computing devices 110, 112, 114, fraud detection system 100 can include any number of customer computing devices 110, 112, 114. Similarly, fraud detection system 100 can include any number of workstation(s) 106, fraud detection computing devices 102, web servers 104, and databases 116.

Workstation(s) 106 are operably coupled to communication network 118 via router (or switch) 108. Workstation(s) 106 and/or router 108 may be located at a store 109, for example. Workstation(s) 106 can communicate with fraud detection computing device 102 over communication network 118. The workstation(s) 106 may send data to, and receive data from, fraud detection computing device 102. For example, the workstation(s) 106 may transmit data related to a transaction, such as a purchase transaction, to fraud detection computing device 102. In response, fraud detection computing device 102 may transmit an indication of whether the transaction is fraudulent. Workstation(s) 106 may also communicate with web server 104. For example, web server 104 may host one or more web pages, such as a retailer's website. Workstation(s) 106 may be operable to access and program (e.g., configure) the webpages hosted by web server 104.

Database 116 can be a remote storage device, such as a cloud-based server, a memory device on another application server, a networked computer, or any other suitable remote storage. Fraud detection computing device 102 is operable to communicate with database 116 over communication network 118. For example, fraud detection computing device 102 can store data to, and read data from, database 116. Although shown remote to fraud detection computing device 102, in some examples, database 116 can be a local storage device, such as a hard drive, a non-volatile memory, or a USB stick.

Communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. Communication network 118 can provide access to, for example, the Internet.

First customer computing device 110, second customer computing device 112, and N^{th} customer computing device 114 may communicate with web server 104 over communication network 118. For example, web server 104 may host one or more webpages of a website. Each of multiple computing devices 110, 112, 114 may be operable to view, access, and interact with the webpages hosted by web server 104. In some examples, web server 104 hosts a web page for a retailer that allows for the purchase of items. For example, an operator of one of multiple computing devices 110, 112, 114 may access the web page hosted by web server 104, add one or more items to an online shopping cart of the web page, and perform an online checkout of the shopping cart to purchase the items. In some examples, web server 104 may transmit data that identifies the attempted purchase transaction to fraud detection computing device 102. In response, fraud detection computing device 102 may transmit an indication of whether the transaction is fraudulent to web server 104.

Fraud detection computing device 102 may determine whether a transaction is to be trusted. If the transaction is trusted (e.g., a trusted transaction), the transaction is allowed. For example, fraud detection computing device 102 may determine that an in-store or online purchase is to be trusted. Fraud detection computing device 102 may transmit a message to store 109 or web server 104, for example, indicating that the in-store or online transaction, respectively, is trusted. Store 109 or web server 104, respectively, may then allow the in-store or online transaction.

If fraud detection system 100 determines that the transaction is not trusted, the transaction may not be allowed. For example, fraud detection computing device 102 may determine that an in-store or online purchase is not to be trusted. Fraud detection computing device 102 may transmit a message to store 109 or web server 104, for example, indicating that the in-store or online transaction, respectively, is not trusted. Store 109 or web server 104, respectively, may then reject (e.g., not allow) the in-store or online transaction. In some examples, untrusted transactions may be allowed if one or more requirements are met. For example, store 109 may allow an untrusted in-store transaction if a customer shows an identification (ID), such as a driver's license or passport. Web server 104 may allow an untrusted online transaction if a customer answers security questions, or uses a different form of payment (e.g., a debit card instead of a credit card, a different credit card, etc.), for example.

To determine transactions that are not trusted (and thus potentially fraudulent), fraud detection computing device 102 executes one or more machine learning processes to generate a “trust score” (e.g., a value indicating whether a transaction should be trusted). In some examples, the machine learning processes may include logistic regression based models (e.g., algorithms), decision tree based models (e.g., XGBoost models). In some examples, the machine learning processes may include deep learning algorithms, or neural networks.

The machine learning processes may be trained with supervised data. For example, the machine learning processes may be trained with features generated from data identifying previous transactions that are labelled trusted or not trusted. In some examples, the machine learning processes are trained with unsupervised data. For example, the machine learning processes may be trained with features generated from data identifying previous transactions including whether payments were rejected or charged back (e.g., payment returned to paying source).

In some examples, to generate a trust score indicating that the transaction is trustworthy, the machine learning process determines whether a transaction was conducted with a device (e.g., computer, mobile phone) that has been determined (e.g., by fraud detection computing device 102) to be “connected to” a payment form (e.g., credit card, debit card) via a “trusted edge.” For example, a device and payment form may be connected via a trusted edge if they were previously used together to make a previous purchase, and the previous purchase was made earlier than a threshold amount of time (e.g., at least 3 months ago). If, for example, the same device and payment form were used to make a previous purchase transaction on a website at least earlier than the threshold amount of time, the machine learning process generates a trust score indicating that the current transaction is trusted (and thus should be allowed). Assuming a scale of 0 to 1, where 0 indicates no trust and 1 indicates full trust, for example, in this example the machine learning process may generate a trust score of 1. Here, the machine learning process executes more quickly than, for example, if the device were not connected to the payment form via a trusted edge, because it identifies the transaction as a trusted transaction based on the device and payment form. Otherwise, the machine learning process may need to operate on additional features to generate a trust score, as is described further below.

Data indicating devices connected to payment forms via trusted edges may be generated by fraud detection computing device 102. For example, fraud detection computing device 102 may generate trusted device data and trusted payment form data for each of a plurality of customers based on historical purchase transactions for each customer. Fraud detection computing device 102 may determine, for each customer, devices and payment forms used in transactions (e.g., purchase transactions) that took place at least earlier than the threshold amount of time. For each transaction, fraud detection computing device 102 may identify a device, and a payment form. If there was no chargeback on the transaction, or no complaint filed (e.g., a customer called to say they did not make a transaction), fraud detection computing device 102 may generate trusted device data and trusted payment form data connecting the device to the payment form via a trusted edge.

Each trusted device identified by the trusted device data is connected to at least one trusted payment form identified by the trusted payment form data via a trusted edge. Fraud detection computing device 102 may generate and/or update trusted device data and trusted payment form data, for example, on a periodic basis (e.g., nightly, monthly, etc.). In some examples, fraud detection computing device 102 may generate and/or update trusted device data and trusted payment form data in real time (e.g., as each in-store on online transaction is received).

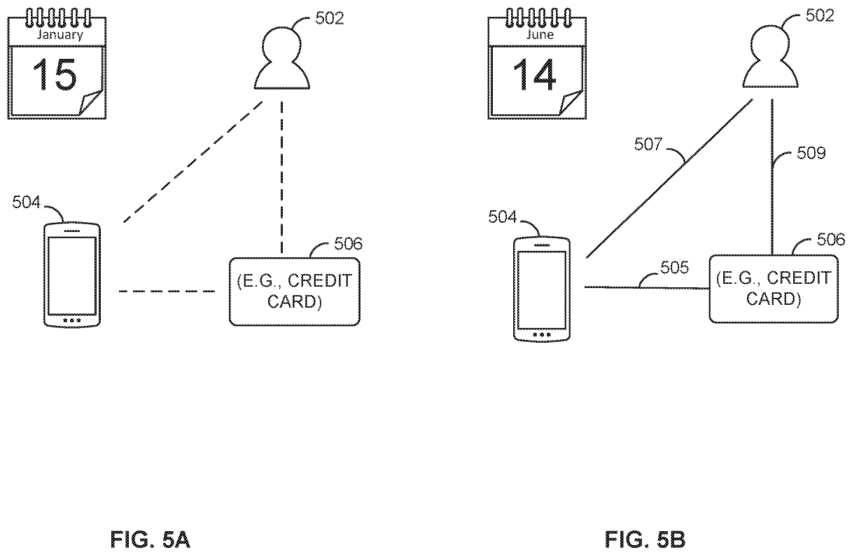

In some examples, fraud detection computing device 102 may connect a second device to a trusted payment form via a trusted edge. For example, assume a first device and a payment form are connected via a trusted edge. Also assume that the customer attempts to make a purchase with a second device using the payment form (i.e., the payment form connected via a trusted edge to the first device). For this transaction using the second device, fraud detection computing device 102 may execute the machine learning process to determine a trust score. Because the second device is not connected to the payment form via a trusted edge, the machine learning process may operate on additional features. The additional features may be generated from, for example, user profile change data (e.g., password reset, address change), customer data, device data, payment data, product risk data, network data (e.g., number of nodes or edges in a graph, e.g., see FIGS. 5A, 5B, 6A, 6B, 7A, 7B, 8A, 8B, and 9), geospatical data (e.g., physical location of a store, billing address, etc.), and data related to previous transactions of the customer (e.g., legitimate transactions, and transactions associated with chargebacks).

In some examples, features can also be generated based on a date or time associate with each of these forms of data. For example, password resets that occurred earlier than a threshold amount of time (e.g., more than 3 months ago) may be ignored, while password resets that occurred during the threshold amount of time (e.g., during the last 3 months) are relevant.

Referring back to the example from above, fraud detection computing device 102 may connect the second device to the payment form via a trusted edge after a threshold amount of time has passed, assuming no chargeback and no complaint becomes associated with the transaction during the threshold amount of time.

In some examples, the attempted purchase with the second device is declined (e.g., based on a trusted score generated by fraud detection computing device 102). Assuming the transaction was at store 109 (e.g., the customer attempted making the purchase using an application on the second device using a payment form linked to the application), store 109 may allow the customer to complete the purchase using the payment form by, for example, scanning the payment form (e.g., credit card, debit card) on a card reader (e.g., credit card or debit card reader). The customer may also need to show a valid ID. If the customer successfully scans the payment form and present the ID, and the purchase is made, fraud detection computing device 102 may then connect the second device with the payment form via a trusted edge.

Although in the above examples trusted edges are described between devices and payment forms, fraud detection computing device 102 can generate trusted edges between other items as well. For example, fraud detection computing device 102 can determine trusted edges between a payment form and a store based on the last time the customer used the payment form at the store. In other examples, fraud detection computing device 102 can generate trusted edges between a customer (e.g., a customer ID) and a device (e.g., based on when the customer last used the device to make a purchase), a customer and a payment form (e.g., based on when the customer last used the payment form to make a purchase), a customer and a home address (e.g., based on when the customer last changed their home address in a user profile), a customer and a store location (e.g., based on when the customer last visited the store to make a purchase), and a customer and a phone number (e.g., based on when the customer last updated their phone number in a user profile), for example.

In some examples, fraud detection computing device 102 assigns values (e.g., weights) to trusted edges. For example, fraud detection computing device 102 may assign a trusted edge between a customer and a device a higher weight than to a trusted edge between a customer and a store. The machine learning process may apply the weights to the trusted edges in generating trust scores.

In some examples, store 109 and web server 104 determine whether a transaction is allowed based on the trust score. For example, transactions with a trust score above a threshold (e.g., 0.8 on a 0 to 1 scale) may be allowed, while transaction with a trust score below the threshold are denied. In some examples, denied transactions may be subsequently allowed if one or more requirements are satisfied, such as scanning a payment form on a card reader, presenting one or more IDs, or any other suitable requirement.

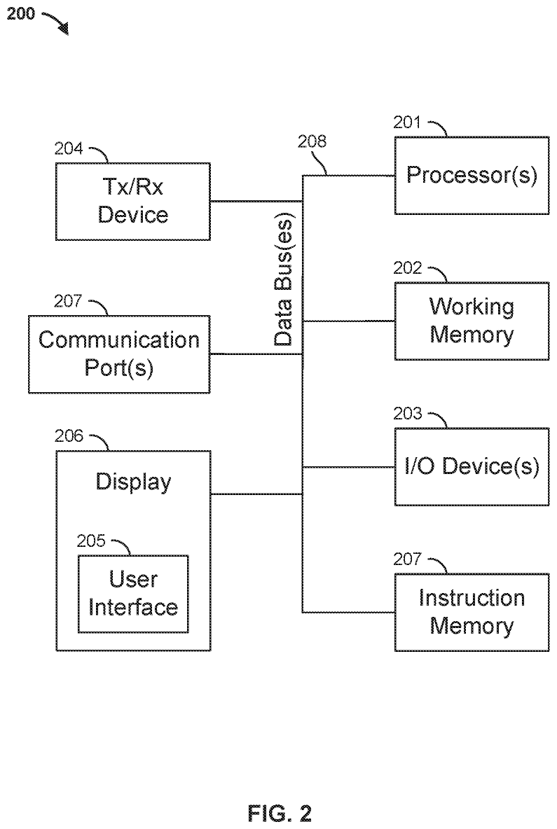

FIG. 2 illustrates the fraud detection computing device 102 of FIG. 1. Fraud detection computing device 102 can include one or more processors 201, working memory 202, one or more input/output devices 203, instruction memory 207, a transceiver 204, one or more communication ports 207, and a display 206, all operatively coupled to one or more data buses 208. Data buses 208 allow for communication among the various devices. Data buses 208 can include wired, or wireless, communication channels.

Processors 201 can include one or more distinct processors, each having one or more cores. Each of the distinct processors can have the same or different structure. Processors 201 can include one or more central processing units (CPUs), one or more graphics processing units (GPUs), application specific integrated circuits (ASICs), digital signal processors (DSPs), and the like.

Processors 201 can be configured to perform a certain function or operation by executing code, stored on instruction memory 207, embodying the function or operation. For example, processors 201 can be configured to perform one or more of any function, method, or operation disclosed herein.

Instruction memory 207 can store instructions that can be accessed (e.g., read) and executed by processors 201. For example, instruction memory 207 can be a non-transitory, computer-readable storage medium such as a read-only memory (ROM), an electrically erasable programmable read-only memory (EEPROM), flash memory, a removable disk, CD-ROM, any non-volatile memory, or any other suitable memory.

Processors 201 can store data to, and read data from, working memory 202. For example, processors 201 can store a working set of instructions to working memory 202, such as instructions loaded from instruction memory 207. Processors 201 can also use working memory 202 to store dynamic data created during the operation of fraud detection computing device 102. Working memory 202 can be a random access memory (RAM) such as a static random access memory (SRAM) or dynamic random access memory (DRAM), or any other suitable memory.

Input-output devices 203 can include any suitable device that allows for data input or output. For example, input-output devices 203 can include one or more of a keyboard, a touchpad, a mouse, a stylus, a touchscreen, a physical button, a speaker, a microphone, or any other suitable input or output device.

Communication port(s) 209 can include, for example, a serial port such as a universal asynchronous receiver/transmitter (UART) connection, a Universal Serial Bus (USB) connection, or any other suitable communication port or connection. In some examples, communication port(s) 209 allows for the programming of executable instructions in instruction memory 207. In some examples, communication port(s) 209 allow for the transfer (e.g., uploading or downloading) of data, such as transaction data.

Display 206 can display user interface 205. User interfaces 205 can enable user interaction with fraud detection computing device 102. For example, user interface 205 can be a user interface for an application of a retailer that allows a customer to purchase one or more items from the retailer. In some examples, a user can interact with user interface 205 by engaging input-output devices 203. In some examples, display 206 can be a touchscreen, where user interface 205 is displayed on the touchscreen.

Transceiver 204 allows for communication with a network, such as the communication network 118 of FIG. 1. For example, if communication network 118 of FIG. 1 is a cellular network, transceiver 204 is configured to allow communications with the cellular network. In some examples, transceiver 204 is selected based on the type of communication network 118 fraud detection computing device 102 will be operating in. Processor(s) 201 is operable to receive data from, or send data to, a network, such as communication network 118 of FIG. 1, via transceiver 204.

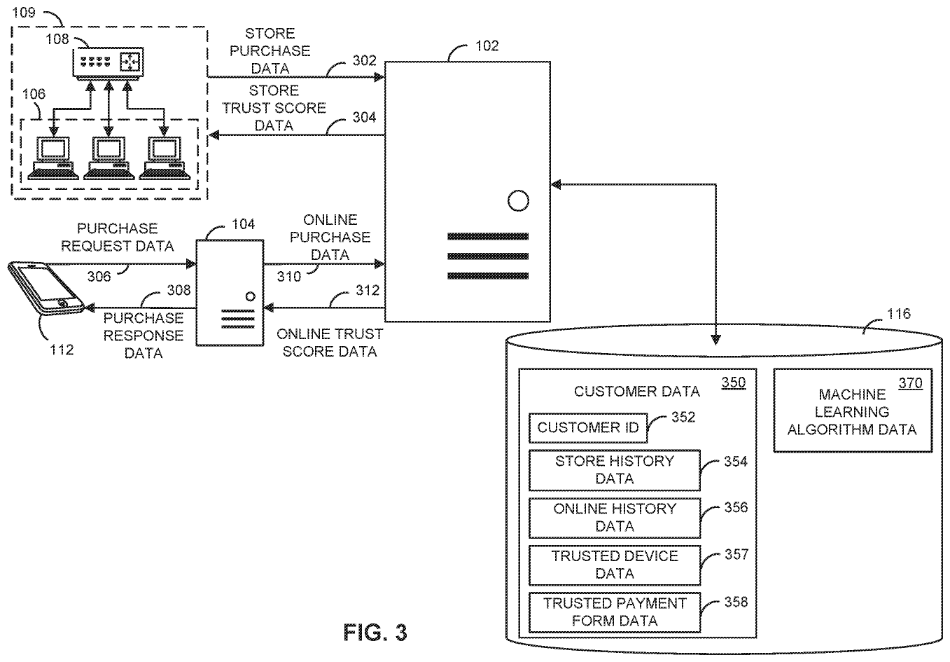

FIG. 3 is a block diagram illustrating examples of various portions of the fraud detection system of FIG. 1. In this example, fraud detection computing device 102 can receive from a store 109 (e.g., from a computing device, such as workstation 106, at store location 109) store purchase data 302 identifying the purchase attempt of one or more items. Store purchase data 302 may include, for example, one or more of the following: an identification of one or more items being purchased; an identification of the customer (e.g., customer ID, passport ID, driver's license number, etc.); an image of an identification of the customer; an identification of a device being used for the purchase (e.g., a device ID, a user name for an application running on the device, a MAC address, etc.); a monetary amount (e.g., price) of each item being returned; the method of payment (i.e., payment form) used to purchase the items (e.g., credit card, cash, check); a Universal Product Code (UPC) number for each item; a time and/or date; and/or any other data related to the attempted purchase transaction.

Fraud detection computing device 102 may execute a machine learning process (e.g., model, algorithm) based on store purchase data 302 to generate a trust score. For example, machine learning algorithm data 370, stored in database 116, may identify and characterize the machine learning process. The machine learning process may be based on decision trees, such as XGBoost, for example. Fraud detection computing device 102 may obtain machine learning algorithm data 370 from database 116, and execute the machine learning process to generate a trust score for the transaction. Fraud detection computing device 102 may then generate store trust score data 304 identifying the trust score. Store trust score data 304 may be transmitted to store 109, for example.

To generate store trust score data 304, fraud detection computing device 102 may determine trusted device data 357 and trusted payment form data 358 for a customer based on store purchase data 302. Trusted device data 357 and trusted payment form data 358 may be linked to a customer via a customer ID, for example. Fraud detection computing device 102 may identify the customer based on a customer ID identified by store purchase data 302, and obtain trusted device data 357 and trusted payment form data 358 for the customer from database 116.

Fraud detection computing device 102 may then execute the machine learning process to determine whether the device and the payment form being used for the purchase identified by store purchase data 302 are trusted to the customer. For example, fraud detection computing device 102 can determine whether trusted device data 357 for the customer includes the device, and whether trusted payment form data 358 for the customer includes the payment form. Further, fraud detection computing device 102 may determine if trusted device data 357 and trusted payment form data 358 indicate a trusted edge linking the device and the payment form.

If fraud detection computing device 102 determines the device and the payment form are trusted to the customer, fraud detection computing device 102 generates store trust score data 304 indicating that the transaction is trusted. For example, on a scale of 0 to 1 (where 0 indicates no trust and 1 indicates full trust), inclusive, fraud detection computing device 102 may generate a score of 1.

If, however, fraud detection computing device 102 determines that the device and the payment form are not trusted to the customer, the machine learning process may further execute to generate store trust score data 304. For example, fraud detection computing device 102 may generate features based on customer data 350 for the customer identified by store purchase data 302. Customer data 350 may include, for example, a customer ID 352 (e.g., a customer name, an ID number, online ID, etc.), store history data 354 identifying historical in-store purchase transactions for the customer, and online history data 356 identifying online purchase transactions for the customer. Store history data 354 and online history data 356 may also include labelled data, such as previously identified trusted transactions for the customer, and chargebacks associated with previous transactions, for example. In some examples, customer data 350 includes one or more of user profile change data, device data, payment data, product risk data, network data, and geospatical data (e.g., physical location of a store the customer has visited, billing address, etc.). In some examples, fraud detection computing device 102 further generates features based on store purchase data 350.

Based on the generated features, fraud detection computing device 102 may execute the machine learning process to generate store trust score data 304 for the transaction. Upon receiving store trust score data 304, store 109 may determine whether to allow the transaction. For example, store 109 may allow the transaction if the trust score identified by store trust score data 304 is at or above a threshold (e.g., 0.8 on a 0 to 1 scale, inclusive). If, however, the trust score is below the threshold, store 109 may deny the transaction. In some examples, store 109 may allow the transaction if one or more requirements are met. For example, store 109 may allow the transaction if a customer ID is presented, or if the customer uses a different form of payment.

In some examples, if the customer attempted to pay with a payment form via (e.g, a credit card) an application executing on a computing device, such as first customer computing device 110, and the transaction was denied, store 109 may allow the transaction if the customer instead swipes the payment form on a card reader.

In some examples, store trust score data 304 identifies whether the transaction is to be allowed. For example, fraud detection computing device 102 may determine if the generated trust score is above the threshold. If the generated trust score is at or above the threshold, fraud detection computing device 102 generates store trust score data 304 identifying that the transaction is to be allowed. If, however, the generated trust score is below the threshold, fraud detection computing device 102 generates store trust score data 304 identifying that the transaction is not to be allowed. Store 109 may then allow or disallow the transaction based on store trust score data 304.

Similarly, fraud detection computing device 102 can receive from a web server 104, such as a web server hosting a retailer's website, online purchase data 310 identifying the purchase attempt of one or more items from the website. For example, web server 104 may receive purchase request data 306 from customer computing device 112, where purchase request data 306 identifies an attempt to purchase one or more items from a website, such as a retailer's website. Web server 104 may generate online purchase data 310 based on purchase request data 306. For example, online purchase data 310 may include one or more of the following: an identification of one or more items being purchased; an identification of the customer (e.g., customer ID, a user name, a driver's license number, etc.); an identification of a device (e.g., a computer, mobile phone, etc.) being used for the purchase (e.g., a device ID, a user name for an application running on the device, a MAC address, etc.); a monetary amount (e.g., price) of each item being returned; the method of payment (i.e., payment form) used to purchase the items (e.g., credit card, cash, check); a Universal Product Code (UPC) number for each item; a time and/or date; and/or any other data related to the attempted purchase transaction.

Fraud detection computing device 102 may execute the machine learning process based on online purchase data 310 to generate a trust score. For example, fraud detection computing device 102 may obtain machine learning algorithm data 370 from database 116, and execute the machine learning process to generate a trust score for the transaction. Fraud detection computing device 102 may then generate online trust score data 312 identifying the trust score. Online trust score data 312 may be transmitted to web server 104, for example. Web server 104 may generate purchase response data 308 identifying the trust score, and may transmit purchase response data 308 to customer computing device 112 in response to receiving purchase request data 306.

To generate online trust score data 312, fraud detection computing device 102 may determine trusted device data 357 and trusted payment form data 358 for the customer based on online purchase data 310. Trusted device data 357 and trusted payment form data 358 may be linked to a customer via a customer ID or user name, for example. Fraud detection computing device 102 may identify the customer based on a customer ID identified by online purchase data 310, and obtain trusted device data 357 and trusted payment form data 358 for the customer from database 116.

Fraud detection computing device 102 may then execute the machine learning process to determine whether the device and the payment form being used for the purchase identified by store purchase data 302 are trusted to the customer. If fraud detection computing device 102 determines the device and the payment form are trusted to the customer, fraud detection computing device 102 generates online trust score data 312 indicating that the transaction is trusted.

If, however, fraud detection computing device 102 determines that the device and the payment form are not trusted to the customer, the machine learning process may further execute to generate online trust score data 312. For example, fraud detection computing device 102 may generate features based on customer data 350 for the customer identified by online purchase data 310. Based on the generated features, fraud detection computing device 102 may execute the machine learning process to generate online trust score data 312 for the transaction. Upon receiving online trust score data 312, web server 104 may determine whether to allow the transaction. For example, web server 104 may allow the transaction if the trust score identified by online trust score data 312 is at or above a threshold. If, however, the trust score is below the threshold, web server 104 may deny the transaction.

In some examples, web server 104 may allow the transaction if one or more requirements are met. For example, web server 104 may allow the transaction if the customer provides additional information, such as a driver's license number, or uses a different form of payment. In some examples, the customer may complete the payment at a store, such as store 109, where the customer may be required to present a customer ID, or swipe the payment from on a card reader.

In some examples, online trust score data 312 identifies whether the transaction is to be allowed. For example, fraud detection computing device 102 may determine if the generated trust score is above the threshold. If the generated trust score is at or above the threshold, fraud detection computing device 102 generates online trust score data 312 identifying that the transaction is to be allowed. If, however, the generated trust score is below the threshold, fraud detection computing device 102 generates online trust score data 312 identifying that the transaction is not to be allowed. Web server 104 may then allow or disallow the transaction based on online trust score data 312.

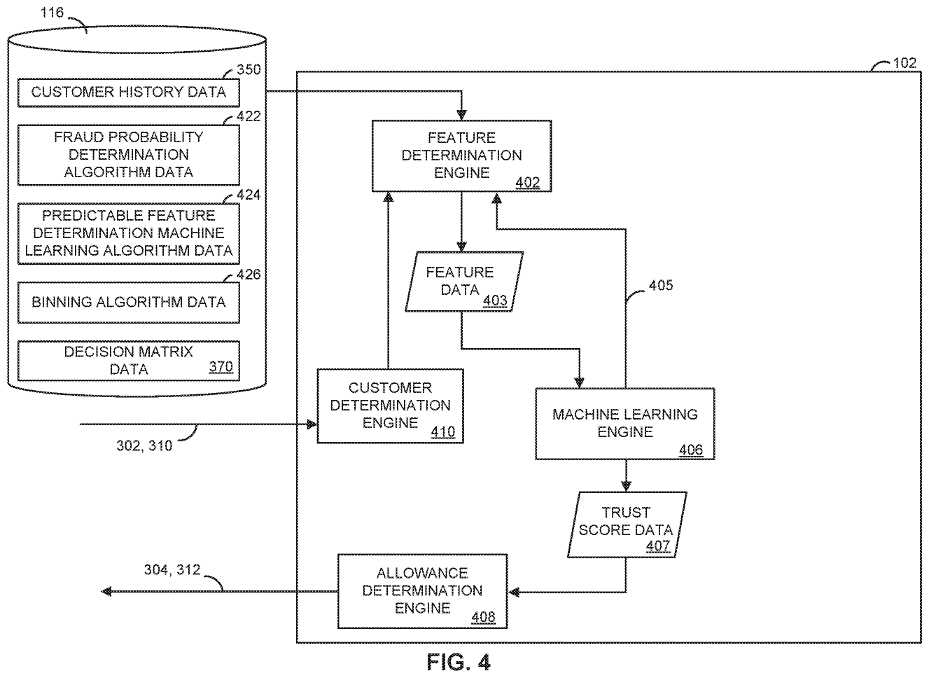

FIG. 4 is a block diagram illustrating examples of various portions of the fraud detection computing device 102 of FIG. 1. As indicated in the figure, fraud detection computing device 102 includes feature determination engine 402, machine learning engine 406, allowance determination engine 408, and customer determination engine 410. In some examples, one or more of feature determination engine 402, machine learning engine 406, allowance determination engine 408, and customer determination engine 410 may be implemented in hardware. In some examples, one or more of feature determination engine 402, machine learning engine 406, allowance determination engine 408, and customer determination engine 410 may be implemented as an executable program maintained in a tangible, non-transitory memory, such as instruction memory 207 of FIG. 2, which may be executed by one or processors, such as processor 201 of FIG. 2.

Customer determination engine 410 may receive a request to determine whether a transaction, such as a purchase transaction, is to be trusted. For example, customer determination engine 410 can receive store purchase data 302 from store 109. Customer determination engine 410 can also receive online purchase data 312 from web server 104. Customer determination engine 410 may identify and obtain, from database 116, one or more of trusted device data 357, trusted payment form data 358, and customer data 350 for a customer associated with store purchase data 302 or online purchase data 312.

Machine learning engine 406 can receive request data (e.g., store purchase data 302 and online purchase data 310), as well as trusted device data 357 and trusted payment form data 358, from customer determination engine 410. Machine learning engine 406 may then execute one or more machine learning processes to generate a trust score for the transaction. For example, machine learning engine 406 may determine whether trusted device data 357 and trusted payment form data 358 identify a trusted edge between a device and a payment form used for the transaction. If machine learning engine 406 determines that trusted device data 357 and trusted payment form data 358 identify a trusted edge between the device and the payment form, machine learning engine 406 generates trust score data 407 identifying a trust score that indicates that the transaction is to be trusted (e.g., a 1 in a 0 to 1 scale). Trust score data 407 is provided to allowance determination engine 408.

If, however, machine learning engine 406 determines that trusted device data 357 and trusted payment form data 358 do not identify a trusted edge between the device and the payment form, machine learning engine 406 may transmit a feature data request 405 to feature determination engine 402.

To generate features, feature determination engine 402 may obtain the data from customer determination engine 410, and generate one or more features. Feature determination engine 402 may execute, for example, a feature extraction algorithm based on the obtained data, and generate feature data 403 identifying the extracted features.

Machine learning engine 406 may obtain feature data 403 from feature determination engine 402, and execute a machine learning process to generate trust score data 407. For example, machine learning engine 406 may provide the feature data as input to a machine learning algorithm, and may execute the machine learning algorithm. The machine learning algorithm may be based on decision trees, such as one based on XGBoost. Execution of the machine learning algorithm can result in generation of a trust score. Machine learning engine 406 may transmit trust score data 407, identifying the trust score, to allowance determination engine 408.

Allowance determination engine 408 may receive trust score data 407, and provide a response to store purchase data 302 or online purchase data 310 based on trust score data 407. For example, assuming store purchase data 302 was received by customer determination engine 410, allowance determination engine 408 may generate store trust score data 304 identifying the trust score received in trust score data 407. Store trust score data 304 may be a message that includes the trust score, where the message is formatted for transmission through a particular communication channel.

In some examples, allowance determination engine 408 determines whether the trust score is beyond a threshold. For example, allowance determination engine 408 may determine if the trust score is at or above the threshold. If the trust score is at or above the threshold, allowance determination engine 408 generates store trust score data 304 identifying that the transaction is to be allowed. If, however, the generated trust score is below the threshold, allowance determination engine 408 generates store trust score data 304 identifying that the transaction is not to be allowed. Store 109 may then allow or disallow the transaction based on store trust score data 304.

Similarly, and assuming online purchase data 310 was received by customer determination engine 410, allowance determination engine 408 may generate online trust score data 312 identifying the trust score received in trust score data 407. Online trust score data 312 may be a message that includes the trust score, where the message is formatted for transmission through a particular communication channel, such as over the internet.

In some examples, allowance determination engine 408 determines whether the trust score is beyond a threshold. For example, allowance determination engine 408 may determine if the trust score is at or above the threshold. If the trust score is at or above the threshold, allowance determination engine 408 generates online trust score data 312 identifying that the transaction is to be allowed. If, however, the generated trust score is below the threshold, allowance determination engine 408 generates online trust score data 312 identifying that the transaction is not to be allowed. Web server 104 may then allow or disallow the transaction based on online trust score data 312.

FIGS. 5A and 5B illustrate trusted and untrusted associations that may be determined by fraud detection computing device 102. For example, FIG. 5A illustrates a customer 502 that has made a purchase using device 504 with payment form 506. Customer 502 may have made the purchase at store 109, for example. Alternatively, customer 502 may have made the purchase on a website hosted by web server 104. Assume the purchase occurred on January 15 of a given year, as indicated. Fraud detection computing device 102 may have stored the purchase transaction as customer data 350 in database 116, for example. As indicated by the dashed lines, device 404 and payment form 406 are not trusted to customer 502 in FIG. 5A.

In FIG. 5B, assume customer 502 attempts to make a second purchase using device 504 with payment form 506. This purchase attempt takes place on June 14 of the same given year (i.e., about 5 months after the initial purchase). Fraud detection computing device 102 may now generate data indicating that device 504 and payment form 506 are trusted to customer 502. For example, assume fraud detection computing device 102 generates trusted edges if the same payment form and device were used to make a previous purchase, and the previous purchase was made earlier than a threshold amount of time, assume 3 months. Also assume that there has been no chargeback for the original transaction, and no complaint filed (e.g., customer indicating that the purchase was unauthorized). Here, because the second purchase is being made after the 3 month period with no chargeback or complaint filed, fraud detection computing device generates data, such as trusted device data 357 and trusted payment form data 358, indicating a trusted edge 505 between device 404 and payment form 406 for customer 502. In particular, device 404 and payment form 406 are now trusted via trusted edges 507 and 509 to customer 502.

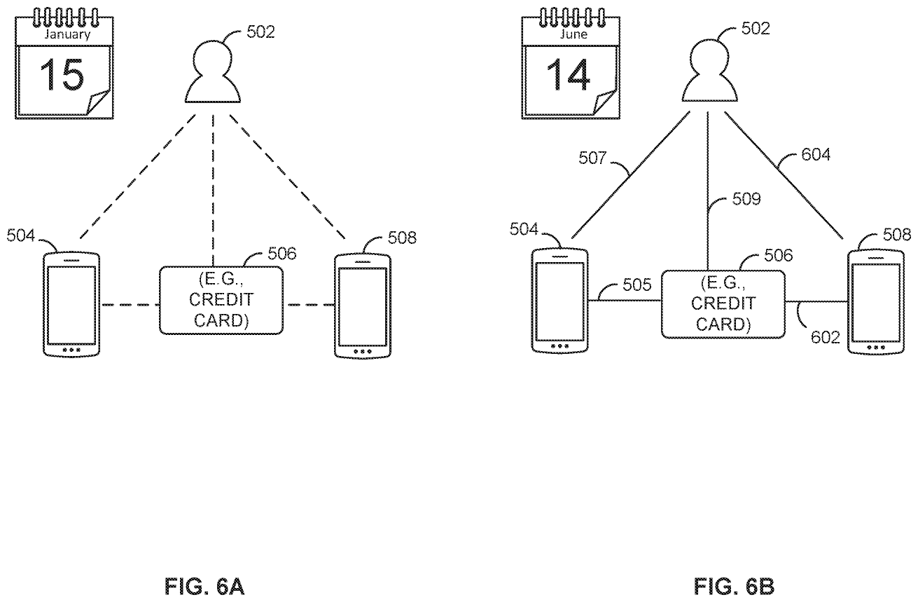

FIG. 6A illustrates an example where customer 502 has previously used a second device 508 with payment form 506 to make a purchase. As in FIG. 5A, device 504 and payment form 506 are not yet trusted to customer 502 (as indicated by the dashed lines in FIG. 6A). In FIG. 6B, customer 502 makes a second purchase attempt using device 504 and payment form 506. As explained above, because the second purchase is being made after at least a minimum amount of time (e.g., a 3 month period) with no chargeback or complaint filed, fraud detection computing device generates data indicating a trusted edge 505 between device 504 and payment form 506 for customer 502. In this example, second device 508 also becomes trusted to customer 502. In particular, a trusted edge 602 is generated between second device 508 and payment form 506. Thus, a first trusted edge is generated between first device 504 and payment form, 506. Additionally, a second trusted edge 602 is generated between second device 508 and payment form 506. Although customer 502 is not attempting to make the second purchase with second device 508, nonetheless second device 508 becomes trusted with payment form 506 because customer 502 had previously used second device 508 with payment form 506 to make a purchase (again, assuming with no chargeback or complaint filed). In addition, a trusted edge 606 is generated between second device 508 and customer 502.

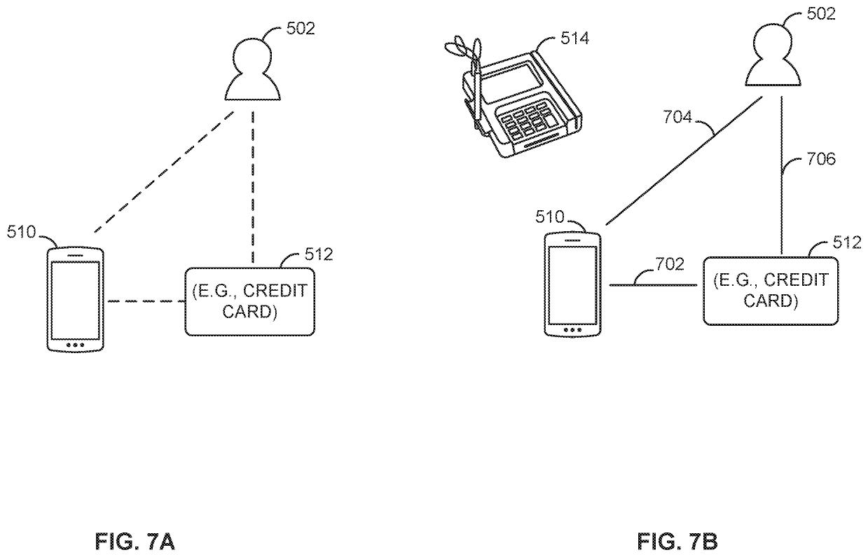

FIG. 7A illustrates customer 502 attempting a purchase with device 510 and payment form 512, for example, via an application executing on device 510 at store 109. Because device 510 and payment form 512 are not trusted to customer 502, the transaction is denied. However, as illustrated in FIG. 7B, customer 502 scans payment from 512 on card reader 514 at store 109. The transaction is now allowed. As a result, fraud detection computing device 102 generates a trusted edge 702 between device 510 and payment form 512. Device 510 and payment form 512 are now trusted, via trusted edges 704 and 706, to customer 502.

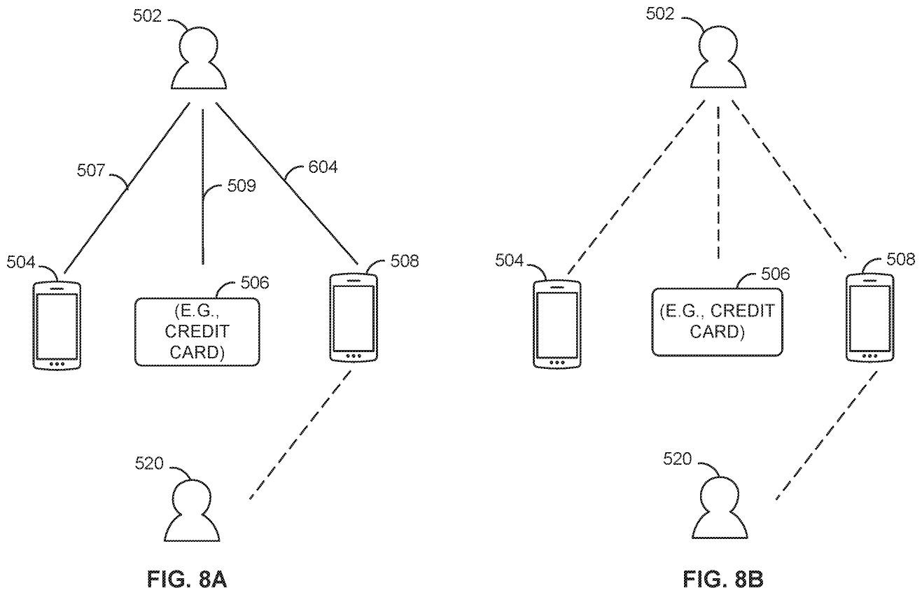

FIG. 8A illustrates first device 504, payment form 506, and second device 508 all trusted to customer 502. However, in this example, assume customer 520 makes an unauthorized purchase with device 508 from a retailer (e.g., on the retailer's website). The purchase may have been made with payment form 506, for example. Also assume that, at some later time, customer 502 places a call to the retailer to indicate that the transaction was unauthorized. As indicated in FIG. 8B, fraud detection computing device 102 distrusts device 508 from customer 502. In addition, fraud detection computing device 102 may also distrust payment form 506 and first device 504 form customer 502. In some examples, to have first device 504, payment form 506, or second device 508 re-trusted to customer 502, customer 502 may make qualifying transactions as described above.

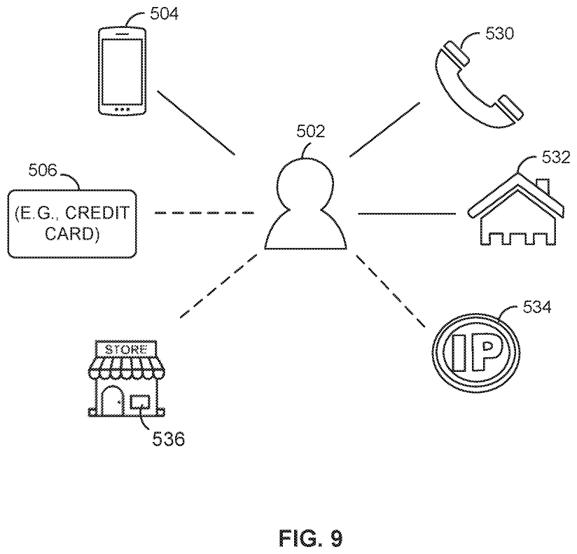

FIG. 9 illustrates various levels of trusted associations that may be determined by fraud detection computing device 102. For example, some associations may be weighted more than others. In this example, device 504, mobile 530, and home 532 are trusted to customer 502 at a first level (as indicated by the solid lines). Payment form 506, store 536 (e.g., a store address for store 536), and IP 534 (e.g., any form of customer identification such as a driver's license) are trusted to customer 502 at a second level (as indicated by the dashed lines). The first level may be a higher level of trust than the second level. For example, on a scale of 0 to 1, inclusive, the first level of trust may be 1, whereas the second level of trust may be 0.75. In some examples, the machine learning process executed by fraud detection computing device 102 may generate trust scores at the various levels.

In addition, to determine if a transaction is to be trusted, the machine learning process may consider one or more trust associations to a customer, such as customer 502. For example, the machine learning process may generate a trust score for a transaction based on a device and payment form being used for the transaction, as well as other trust associations for the customer. For example, the machine learning process may generate a trust score of 0.8 for a customer using a trusted device and trusted payment form in a current transaction, but a transaction score of 0.9 for a customer that, in addition to using a trusted device and trusted payment form in a current transaction, also has an addition trusted payment form (e.g., that is not being used in the current transaction).

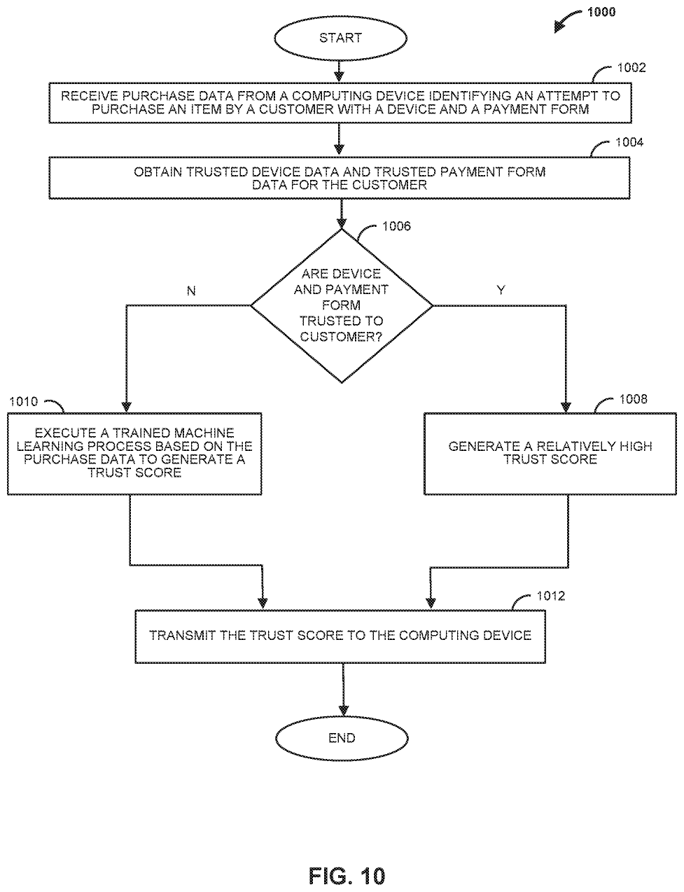

FIG. 10 is a flowchart of an example method 1000 that can be carried out by the fraud detection system 100 of FIG. 1. Beginning at step 1002, purchase data is received from a computing device. The purchase data identifies an attempt, by a customer, to purchase an item with a device and a payment form. For example, fraud detection computing device 102 may receive online purchase data 310 from web server 104. At step 1004, trusted device data and trusted payment form data for the customer is obtained. For example, fraud detection computing device 102 may obtain trusted device data 357 and trusted payment form data 358 from database 116 for the customer associated with the purchase data.

At step 1006, a determination is made as to whether the device and the payment form identified in the purchase data are trusted based on the obtained trusted device data and trusted payment data. For example, fraud detection computing device 102 may determine if obtain trusted device data 357 and trusted payment form data 358 identify a trusted edge between the device and the payment form. If the device and the payment form are trusted, the method proceeds to step 1008, where a relatively high target score is generated. For example, fraud detection computing device 102 may generate a target score that indicates the purchase is to be allowed.

Otherwise, if at step 1006, the device and the payment form are not trusted, the method proceeds to step 1010. At step 1010, a trained machine learning process is executed. The trained machine learning process may be based on decision trees, for example, and may be trained with labelled historical purchase transaction data. The trained machined learning process operates on the purchase data to generate a trust score.

From steps 1008 and 1010, the method proceeds to step 1012, where the generated trust score is transmitted to the computing device. The method then ends.

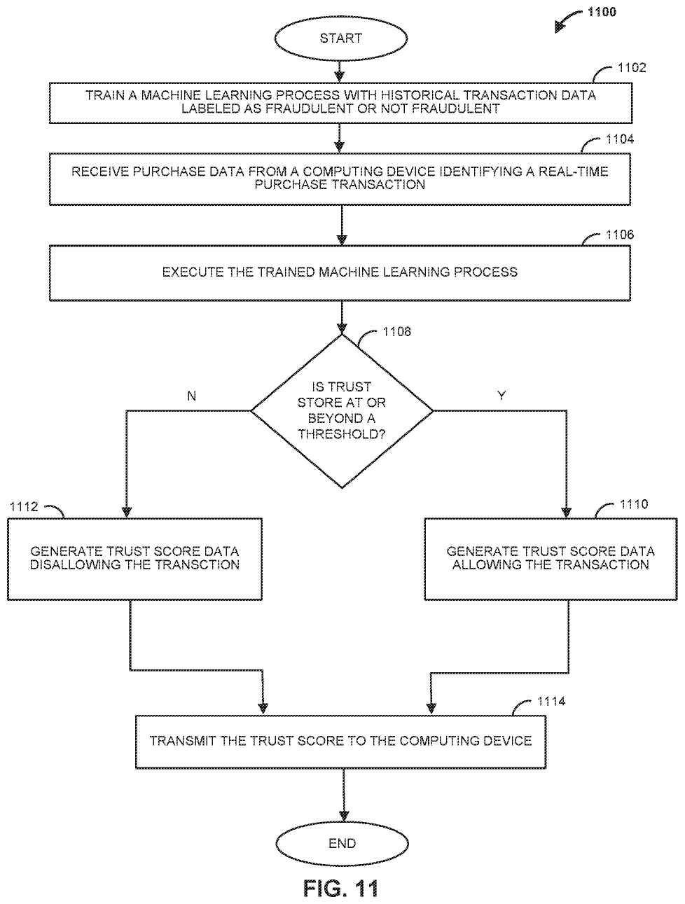

FIG. 11 is a flowchart of another example method 1100 that can be carried out by the fraud detection system 100 of FIG. 1. At step 1102, a machine learning process is trained with historical transaction data labelled as fraudulent or not fraudulent. The machine learning process may be based on decision trees, such as XGBoost, or logistic regression, for example. At step 1104, purchase data is received from a computing device. The purchase data identifies a real-time purchase transaction (e.g., a purchase being made at store 109 or on a website hosted by web server 104).

The method proceeds to step 1106, where the trained machine learning process is executed. The trained machined learning process operates on the purchase data to generate a trust score.

Proceeding to step 1108, a determination is made as to whether the trust score is beyond a threshold. For example, a determination may be made as to whether the trust score is at or above the threshold. If the trust score is beyond the threshold, the method proceeds to step 1110 where trust score data is generated indicating that the transaction is to be allowed. If at step 1108, however, the trust score is not beyond the threshold (e.g., below the threshold), the method proceeds to step 1112. At step 1113, trust score data is generated indicating that the transaction is not be allowed.

From each of steps 1110 and 1112, the method proceeds to step 1114. At step 1114, the trust score is transmitted to the computing device. The method then ends.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The foregoing is provided for purposes of illustrating, explaining, and describing embodiments of these disclosures. Modifications and adaptations to these embodiments will be apparent to those skilled in the art and may be made without departing from the scope or spirit of these disclosures.

What is claimed is:

1. A system comprising:
a computing device configured to:
receive purchase data identifying a purchase attempt using a first device and a first payment form;
determine whether the first device is trusted to the first payment form based on first trust data obtained from a database, wherein:
if the first device is trusted to the first payment form, generate a first trust value; and
if the first device is not trusted to the second payment form:
execute a machine learning process based on the purchase data; and
generate a second trust value based on execution of the machine learning process;
generate trust score data based on at least one of the first trust value or the second trust value; and
transmit the trust score data to another computing device.

2. The system of claim 1, wherein determining that the first device is trusted to the first payment form comprises:
determining that a first previous purchase using the first device and the first payment form was completed earlier than at least a threshold amount of time from receiving the purchase data;
generating the first trust data indicating that the first device is trusted to the first payment form; and
storing the first trust data in the database.

3. The system of claim 2, wherein the computing device is configured to:
determine a second previous purchase using a second device and the first payment form; and
generate second trust data indicating that the second device is trusted to the first payment form.

4. The system of claim 2, wherein determining that the first device is trusted to the first payment form comprises determining that no chargeback occurred on the first previous purchase.

5. The system of claim 2, wherein determining that the first device is trusted to the first payment form comprises determining that no unauthorized transaction complaint was received for the first previous purchase.

6. The system of claim 1, wherein the first device is not trusted to the first payment form, wherein the computing device is configured to:
receive, from the other computing device, response data indicating that at least one transaction requirement was satisfied;
update the first trust data to indicate that the first device is trusted to the first payment form; and
store the first trust data in the database.

7. The system of claim 1, wherein the first trust score indicates that the purchase attempt is trustworthy.

8. The system of claim 1, wherein the computing device is configured to train the machine learning process with labelled historical data indicating a plurality of historical transactions, where each historical transaction is labeled as fraudulent or not fraudulent.

9. The system of claim 1, wherein the machine learning process is based on decision trees.

10. The system of claim 1, wherein generating the trust score data comprises:
determining whether the second trust score is beyond a threshold, wherein:
if the second trust score is beyond the threshold, the trust score data indicates that the purchase attempt is to be allowed; and
if the second trust score is not beyond the threshold, the trust score data indicates that the purchase attempt is not to be allowed.

11. The system of claim 1, wherein executing the machine learning process comprises:
generating features based on the purchase data; and
providing the generated features as input to the machine learning process.

12. A method comprising:
receiving purchase data identifying a purchase attempt using a first device and a first payment form;
determining whether the first device is trusted to the first payment form based on first trust data obtained from a database, wherein:
if the first device is trusted to the first payment form, generating a first trust value; and
if the first device is not trusted to the second payment form:
executing a machine learning process based on the purchase data; and
generating a second trust value based on execution of the machine learning process;
generating trust score data based on at least one of the first trust value or the second trust value; and
transmitting the trust score data to another computing device.

13. The method of claim 12 wherein determining that the first device is trusted to the first payment form comprises:
determining that a first previous purchase using the first device and the first payment form was completed earlier than at least a threshold amount of time from receiving the purchase data;
generating the first trust data indicating that the first device is trusted to the first payment form; and
storing the first trust data in the database.

14. The method of claim 13 comprising:
determining a second previous purchase using a second device and the first payment form; and
generating second trust data indicating that the second device is trusted to the first payment form.

15. The method of claim 12 wherein the first device is not trusted to the first payment form, wherein the method comprises:
receiving, from the other computing device, response data indicating that at least one transaction requirement was satisfied;
updating the first trust data to indicate that the first device is trusted to the first payment form; and
storing the first trust data in the database.

16. The method of claim 12 wherein generating the trust score data comprises:
determining whether the second trust score is beyond a threshold, wherein:
if the second trust score is beyond the threshold, the trust score data indicates that the purchase attempt is to be allowed; and
if the second trust score is not beyond the threshold, the trust score data indicates that the purchase attempt is not to be allowed.

17. The method of claim 12, wherein the first trust score indicates that the purchase attempt is trustworthy.

18. A non-transitory computer readable medium having instructions stored thereon, wherein the instructions, when executed by at least one processor, cause a device to perform operations comprising:
receiving purchase data identifying a purchase attempt using a first device and a first payment form;
determining whether the first device is trusted to the first payment form based on first trust data obtained from a database, wherein:
if the first device is trusted to the first payment form, generating a first trust value; and
if the first device is not trusted to the second payment form:
executing a machine learning process based on the purchase data; and
generating a second trust value based on execution of the machine learning process;
generating trust score data based on at least one of the first trust value or the second trust value; and
transmitting the trust score data to another computing device.

19. The non-transitory computer readable medium of claim 18 further comprising instructions stored thereon that, when executed by at least one processor, further cause the device to perform operations comprising:
determining that a first previous purchase using the first device and the first payment form was completed earlier than at least a threshold amount of time from receiving the purchase data;
generating the first trust data indicating that the first device is trusted to the first payment form; and
storing the first trust data in the database.

20. The non-transitory computer readable medium of claim 19 further comprising instructions stored thereon that, when executed by at least one processor, further cause the device to perform operations comprising:
determining a second previous purchase using a second device and the first payment form; and
generating second trust data indicating that the second device is trusted to the first payment form.
